(19) United States
(12) Patent Application Publication
(10) Pub. No.: US 2007/0294647 A1
(43) Pub. Date: Dec. 20, 2007

(54) Transferring software assertions to hardware design language code

(75) Inventors: David Fong, San Jose, CA (US); Zheng (Joy) Zhang, Shanghai (CN); Qi (Christine) Chen, Shanghai (CN)

Correspondence Address: THOMAS, KAYDEN, HORSTEMEYER & RISLEY, LLP, 600 GALLERIA PARKWAY, STE 1500, ATLANTA, GA, 30339, US

(73) Assignee: Via Technologies, Inc.

(21) Appl. No.: 11/445,013

(22) Filed: Jun. 1, 2006

(51) Int. Cl. G06F 17/50; G06F 9/45

(52) U.S. Cl. 716/3; 717/137

(57) ABSTRACT

Systems and methods are disclosed for transferring assertions in a software programming language source file to an HDL source file. In one such method, a first source file contains source code in a software programming language and a second source file contains HDL source code translated from the source code in the first source file. The second source file excludes assertions translated from the source code in the first source file. This method comprises the steps of: reading a software assertion from from the first source file; locating a second block within the second source file, where the second block corresponds to a first block that contains the software assertion; mapping the software assertion to a hardware assertion expressed in the HDL; determining a location within the second block for insertion of the hardware assertion; and inserting the hardware assertion at the determined location within the second source file.

### FIELD OF THE INVENTION

The present invention relates to software tools for designing digital integrated circuits, and more specifically, to a tool for using hardware design language assertions.

### BACKGROUND

Integrated circuit (IC) design typically involves several stages, each using a different tool of suite of tools. An IC designer typically writes code in one of several programming languages. Concurrent with the code-writing process is simulation, in which the designer runs a simulator tool to test the design, using the program code as input. As simulation reveals problems, the designer edits the code to fix problems, and simulates again. After simulation, a synthesizer translates the code into a logical representation of an IC. Other IC tools then transform this logical representation into a physical IC, in the form of a Field Programmable Gate Array (FPGA), Application-Specific Integrated Circuit (ASIC), or custom silicon IC.

Several types of programming languages are available to an IC designer. One family of languages can be described as Hardware Design Languages (HDL), also known as Register Transfer Languages (RTL). Commonly known RTLs include Verilog and VHDL. RTLs are considered to be “low-level” because they describe hardware-specific features such as timing and parallelism. Another choice for IC design includes languages such as C and C++ (and variants thereof) that were traditionally used to develop software rather than hardware. These software languages allow the designer to write code at a much higher level of abstraction, which typically increases designer productivity.

Both C/C++ and HDL code commonly includes assertions to verify that the code is an accurate implementation of the intended design. An assertion is a statement which expresses how a particular design feature should or should not behave. For example, the code for a particular block may assume that only one of two inputs is active at any one time. As another example, a block may assume that an input will never be larger than a certain maximum value. Each of these assumptions made by the designer can be expressed as assertion.

Because most simulation and synthesis tools use HDL as input, rather than C/C++, an IC designer may choose to write code in C/C++ and translate the code into HDL. The translation can be done manually, automatically, or using a combination of both techniques. However, not all translation tools translate C++ assertions into appropriate HDL assertions. Therefore, such a tool is needed.

### SUMMARY

Systems and methods are disclosed for transferring assertions in a software programming language source file to a hardware design language (HDL) source file. In one such method, a first source file contains source code in a software programming language and a second source file contains HDL source code that is translated from the source code in the first source file. The second source file excludes assertions that are translated from the source code in the first source file. This method comprises the steps of: reading a software assertion from the first source file; locating a second block within the second source file, where the second block corresponds to a first block that contains the software assertion; mapping the software assertion to a hardware assertion expressed in the HDL; determining a location within the second block for insertion of the hardware assertion; and inserting the hardware assertion at the determined location within the second source file.

### DESCRIPTION OF THE DRAWINGS

Many aspects of the invention can be better understood with reference to the following drawings. The entities in the drawings are not necessarily to scale, emphasis instead being placed upon clearly illustrating the principles of the present invention.

FIG. 1 is a block diagram showing the overall data flow in using the method of transferring software assertions into HDL code.

FIGS. 2A is a block level diagram showing the hierarchy of software code and hardware code, and the correspondence between them.

FIG. 2B is a diagram showing of how the files in the software code and the hardware code express the hierarchy shown in FIG. 2A.

FIG. 3 shows another type of hierarchy found in the software code and the hardware code.

FIG. 4 shows an example software function within the software code0, and a corresponding hardware module within the hardware code.

FIG. 5 shows the hardware module of FIG. 4 after the method disclosed herein has transferred assertions from the software function of FIG. 4.

FIG. 6 shows how the method disclosed herein maps the assertion from C/C++ form to HDL form.

FIG. 7 is a block diagram of one embodiment of a system for transferring software assertions into HDL code

FIG. 8 is a flowchart of one embodiment of the method of transferring software assertions into HDL code.

FIG. 9 is a hardware block diagram of a general-purpose computer which can be used to implement the method of transferring software assertions into HDL code.

### DETAILED DESCRIPTION

The method of transferring software assertions into HDL code disclosed herein: examines software code in conjunction with HDL code that was translated from the software code; translates software assertions in the examined software code into HDL assertions; and inserts the HDL assertions into the translated HDL code.

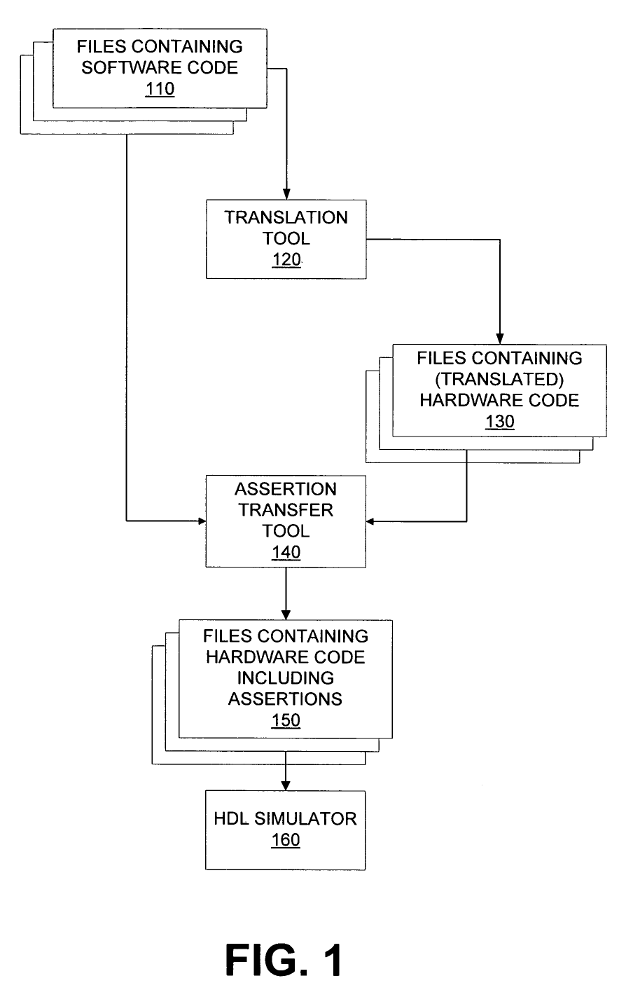

FIG. 1 is a block diagram showing the overall data flow in using the method of transferring software assertions into HDL code. Two sets of input files are used. Both sets of files are typically arranged in various subdirectories. One set of input files contains software code 110, which is code written in a software programming language (e.g., C, C++). These input files include assertions written in the same software programming language. This software code 110 is input to a translation tool 120, which translates the software code into a hardware description language (e.g., VHDL, Verilog). The translation tool 120 produces translated hardware code 130, which is the second set of input files used by an assertion transfer tool 140.

Importantly, the translated hardware code 130 does not contain HDL assertions translated from the software language. However, it may contain other assertions, produced by the translation tool 120, or added manually after the translation process.

The two input files are processed by the assertion transfer tool 140, a computer program that implements the method of transferring software assertions into HDL code. The assertion transfer tool 140 produces hardware code 150 that contains the original HDL code as well as assertions translated from the software language. The method reads software language assertions in the software code 110, translates the software assertions into HDL assertions, and places the HDL assertions in the appropriate location within the translated hardware code 130. The hardware code containing assertions 150 can then be used as input by an HDL simulator 160.

One skilled in the art of software development will realize that the assertion transfer tool 140 can be implemented in a variety of languages, both scripted and compiled. A non-limiting list of scripting languages includes per1, awk, shell script, and VBScript. A non-limiting list of compiled languages includes C, C++, C#, Java, and Visual Basic.

Although contained in more than one file, the software code 110 when considered as a whole forms a hierarchy of software entities. Similarly, hardware code 130 is contained in more than one file, but when considered a whole forms a hierarchy of hardware entities. In Verilog these entities are modules. In C, these entities are functions. In C++, these entities are classes, and classes contain functions.

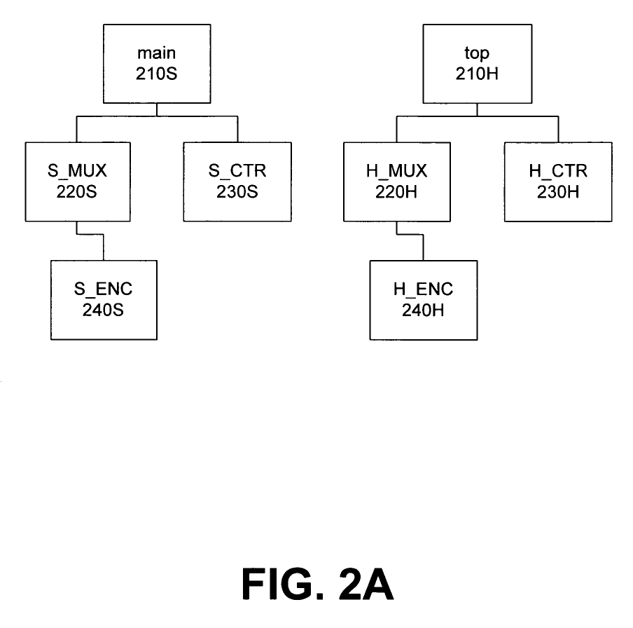

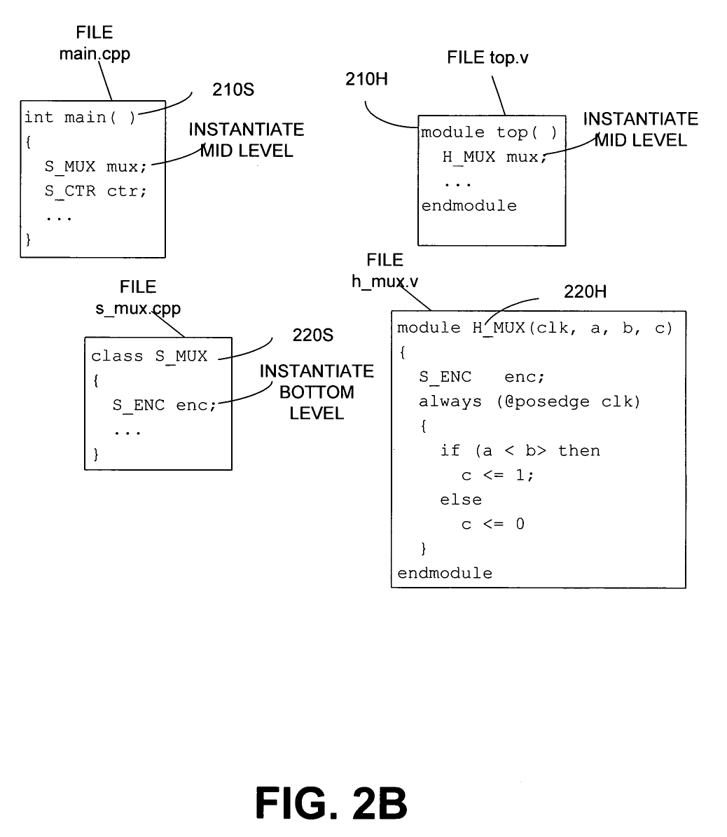

FIGS. 2A and 2B are two different views showing the two hierarchies, and the correspondence between them. FIG. 2A is a block level diagram of the hierarchies. At the top of the hierarchy is a single top-level entity 210. In C/C++, this top-level software entity 210S is a function with the name “main”. In Verilog, the top-level hardware entity 210H is a module with the name “top”. Thus, the hardware code 130 contains a top-level hardware entity 210H which corresponds to the top-level software entity 210S.

An entity at a particular level can create, or instantiate, other entities at the next lower level. In the example in FIG. 2A, classes 220S (“S_MUX”) and 230S (“S CTR”) are mid-level software entities instantiated by “main” (210S), while modules 220H (“H_MUX”) and 230H (“H_CTR”) are mid-level hardware entities instantiated by “top” (210H). Similarly, class 240S (“S_ENC”) is a bottom-level entity instantiated by “S_MUX” (220S) and module 240H (“H_ENC”) is a bottom-level entity instantiated by “H_MUX” (220B).

Importantly, the name of hardware module 220H (“H_MUX”) can be derived from the name of software class 220S (“S_MUX”), because the process which translated the C/C++ software code 110 into the Verilog hardware code 130 (either automated or manually) follows a predetermined naming scheme. When transferring software assertions into HDL code, the method disclosed herein examines the files that make up the software code 110 to discover the software code hierarchy, and examines the files that make up the hardware code 130 to discover the hardware code hierarchy. The predetermined naming scheme then allows the method to discover the correspondence between the two hierarchies.

FIG. 2B is a diagram showing of how the files in the software code 110 and the hardware code 130 express the hierarchy shown in FIG. 2A. The function “main” (210S) instantiates class “S_MUX” (220S), and class “S_MUX” (220S) instantiates class “S_ENC” (240S). In the corresponding hardware hierarchy, module “top” (210H) instantiates module “H_MUX” (220H), and module “H_MUX” (220H) instantiates module “H_ENC” (240H).

In the embodiment of FIG. 2B, each class and standalone function (e.g., “main”) is located in a separate file, each module is located in a separate file, and the filename for a particular module can be derived from the filename of the corresponding class (e.g., h_mux.v from s_mux.cpp). Therefore, given a particular software class contained in a particular file, the method of transferring software assertions into HDL code can easily determine the module corresponding to a class, and the file containing this module. In another embodiment, a file may contain more than one class or module. In this case, the method of transferring software assertions into HDL code derives the module name from the class name, and then searches files within the hardware code 130 for a hardware source file containing that module name.

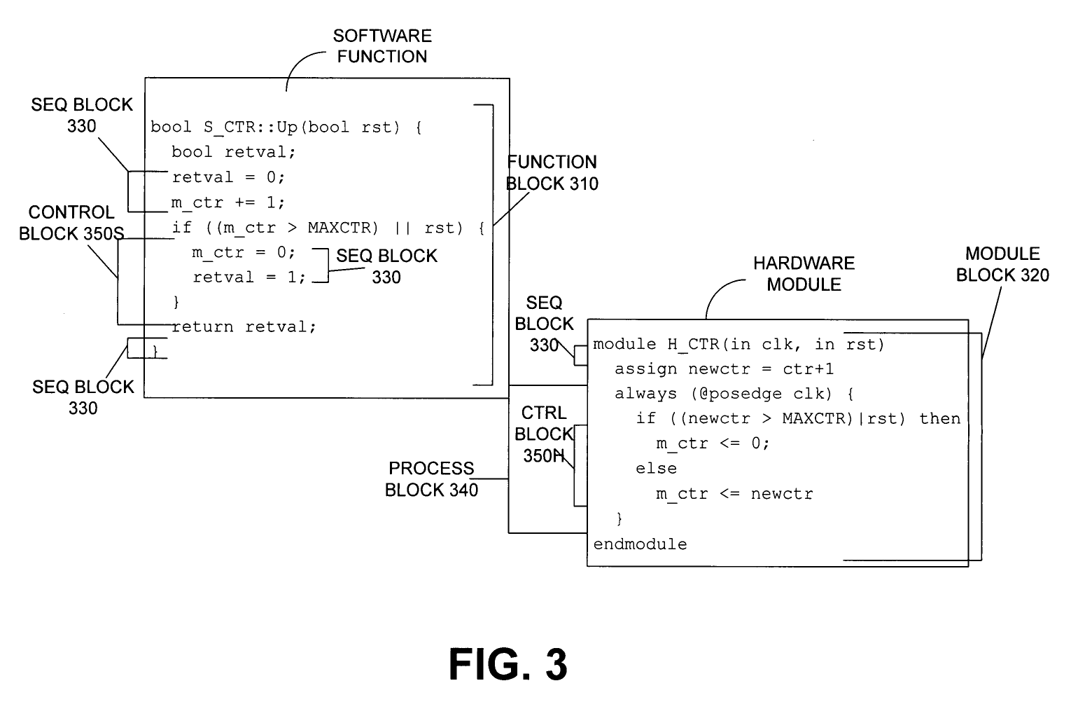

FIG. 3 shows another type of hierarchy found in the software code 110 and the hardware code 130: both software entities and hardware entities are composed of blocks. At the top of this hierarchy, each software or hardware entity comprises a single top-level block. Each function of a software class comprises a single top-level function block 310. Each hardware module comprises a single top-level module block 320.

Each function block 310 or module block 320 contains one or more sequence blocks 330. A hardware module can contain another kind of block, a process block 340, which has no counterpart in a software class.

Within a sequence block 330, statements are executed sequentially. A control block 350 is used to transfer control out of the sequence. Although syntax varies among languages, most software and hardware programming languages include conditional control blocks (e.g. IF) and repetitive control block (e.g., FOR, WHILE). In FIG. 3, block 350S is a C/C++ software conditional block (IF), and block 350H is a corresponding Verilog hardware conditional block (IF-THEN-ELSE).

As mentioned earlier, the method of transferring software assertions into HDL code translates software assertions into HDL assertions, and places the HDL assertions in the appropriate location within the hardware code 130. The method uses the blocks described in connection with FIG. 3 to determine the appropriate location for insertion of the HDL assertion. More specifically, the appropriate location for the HDL assertion within the hardware code 130 is specified in a manner that is relative to blocks in the corresponding software code 110.

For example, if a software assertion was identified as being located between block X and block Y in the software code 110, then the location for the HDL assertion might be between corresponding blocks X′ and Y′ in the hardware code 130. One of ordinary skill in the art of HDL code translation should recognize that the structure of translated HDL code can be much different than the software code from which it is translated. Therefore, the appropriate location for the HDL assertion in this example might be after blocks X′ and Y′, or possibly even within block X′ or Y′, depending on the structure of hardware code 130 and software code 110.

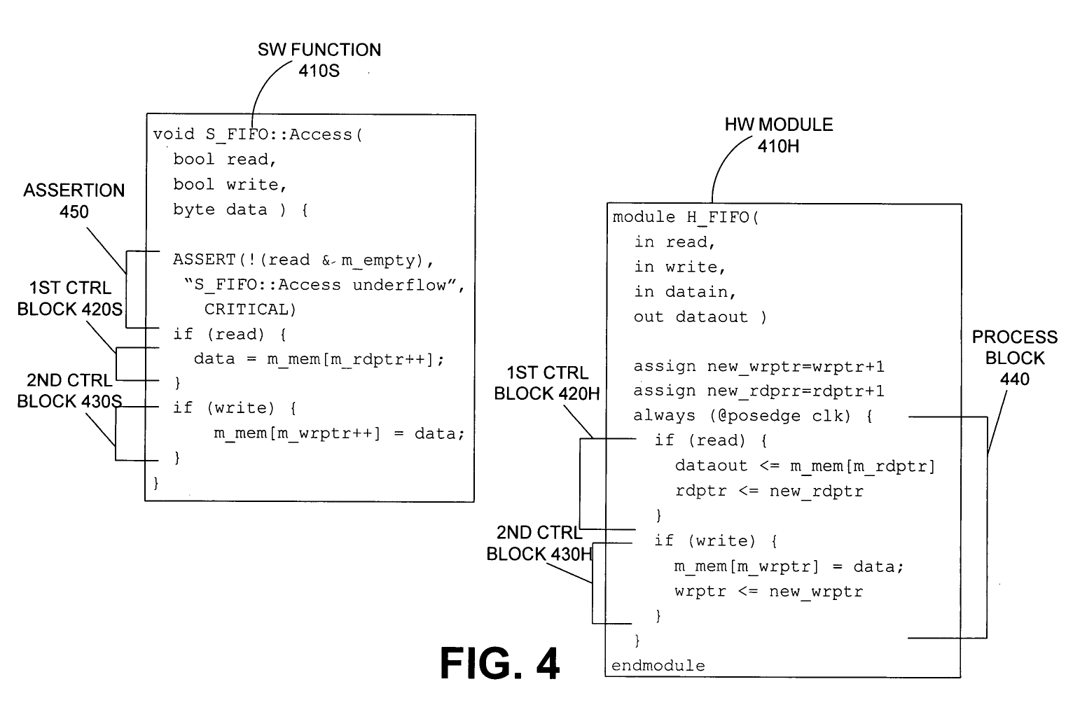

FIG. 4 shows an example software function 410S within the software code 110, and a corresponding hardware module 410H within the hardware code 130. The function 410S contains two control blocks: “IF read” 420S; and “IF write” 430S. The corresponding hardware module 410H contains two corresponding control blocks, 420H and 430H. In the module 410H, these two control blocks are contained within a process block 440 which has no counterpart in the module 410H.

The software function 410S also contains one assertion: “ASSERT(!(read & m_empty))” (450). This assertion is located before the first control block 420S. As can be seen in FIG. 4, the hardware code 130 does not contain assertions that were translated from the software assertion 450.

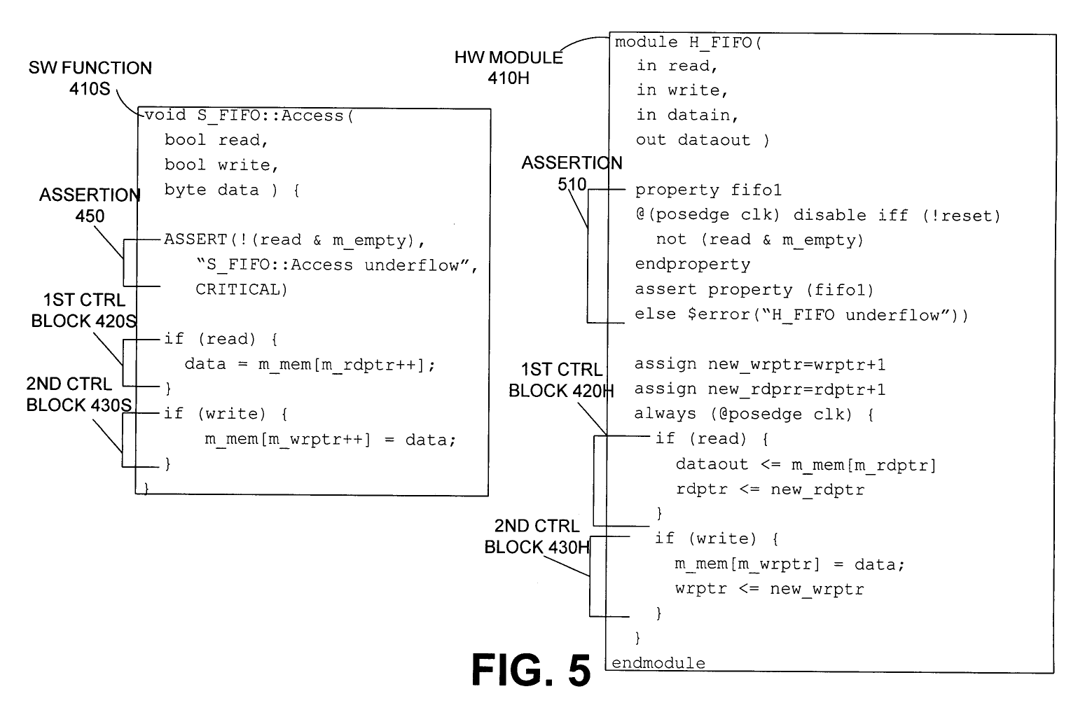

FIG. 5 shows the hardware module 410H after the method disclosed herein has transferred assertions from the software function 410S in the software code 110. The hardware assertion (510) is a translation of software assertion 450. The method places the hardware assertion 510 before the first control block 420H in the hardware module 410H, since the corresponding software assertion 450 is located before the first control block 420S in the software function 410S. As noted earlier, in other cases hardware assertion 510 might be inserted within the control block 420H, or after the control block 420H, depending on the structure of hardware code 130 and software code 110.

The example in FIG. 5 is relatively simple, with only two sequence blocks, and assertions located before the first sequence block. More complicated examples would include sequence and control blocks at many levels of combination. However, as described earlier, tools are known which map software code blocks to corresponding HDL blocks. Therefore, a person of ordinary skill in the art of translating software code to HDL will understand how to determine appropriate locations within the HDL code for transferred software assertions.

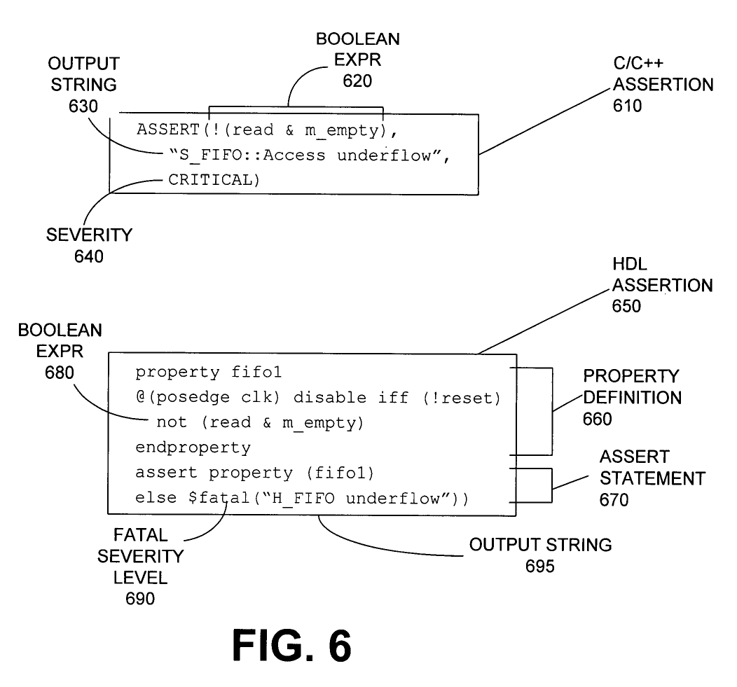

FIG. 5 showed a scenario where a hardware assertion is placed within a hardware module when transferring a software assertion into an HDL file. FIG. 6 shows how the method disclosed herein maps the assertion itself from C/C++ form to HDL form. As explained earlier, an assertion expresses a condition that is expected to hold true. A typical software assertion 610 is implemented as a preprocessor macro with three parameters: a boolean expression 620, which is expected to hold true; an output string 630 which is displayed if the expression does not hold true; and a severity level 640 which determines whether the code stops executing if the expression does not hold true.

In the example of FIG. 6, the software assertion 610 expects that the FIFO's read and empty flag variables will not both be true. If this boolean expression 620 doesn't evaluate to true at runtime—if read and empty are both true—then the descriptive string “S_FIFO::Access underflow” (630) is displayed. Since the severity level (640) is CRITICAL, then the code stops executing (either breaking to the debugger, or exiting the program, depending on the implementation of the ASSERT macro).

The method disclosed herein translates the software assertion 610 into the Verilog assertion 650. This example uses a variation of Verilog called System Verilog with Assertions (SVA), which includes language constructs for assertions. One of these constructs is a property. An important distinction between software code and hardware code is that hardware code is clocked. Software can simply test the value of a variable to determine if a boolean expression is true. But in hardware, the variable is a signal, and must be tested with reference to a clock.

Therefore, the method disclosed herein implements a Verilog assertion in two portions: a property definition 660, which allows clocking references; and an ASSERT statement 670. The property definition 660 defines a Verilog named property, which in this case has the generic name “fifol.” The property definition 660 includes an ALWAYS block which contains a clocking reference, and within the ALWAYS block, the boolean expression 680 which is expected to hold true.

The ASSERT statement 670 follows the property definition 660. The condition that is expected to hold true is the named property, defined above, where the property definition in turn contains the boolean expression 680. If the named property does not hold true, the ASSERT statement 670 includes the Verilog $FATAL statement (690) and the output string 695. The $FATAL statement 690 displays the output string 695 and terminates the simulation with an error code.

Use of the $FATAL statement here corresponds to the severity level of CRITICAL in the software assertion 610. A severity level of NORMAL in a software assertion would instead map to the Verilog $ERROR or $WARNING statement, which will display the output string 695 but will not terminate the simulation.

Another type of software assertion, used with a SWITCH or CASE control statement, does not explicitly include a boolean expression. Instead, the location of the assertion within the control statement implies a boolean expression. An example of this can be seen in the code below:

switch(access_type)

case Read:

; more code

case Write:

; more code

default:

ASSERT(0, “invalid value for access_type”, NORMAL);

Here, the assertion under the DEFAULT label will be executed only if access_type is not equal to Read or Write. This is equivalent to a boolean condition:

((access_type !=Read) && access_type !=Write))

However, this boolean condition is implied by the location of the assertion within the SWITCH/CASE control block, and thus it is unnecessary to included the expression as a parameter to the ASSERT macro. This specialized type of software assertion can be efficiently mapped to the $INSET operator supported by the System Verilog property statement. The equivalent System Verilog assertion is therefore:

property invalid_access_type;

@(posedge clk) not ($inset(access_type, ‘Read, ‘Write ))

endproperty
assert property (invalid_access_type)

else $error (“H_FIFO: invalid access type!”)

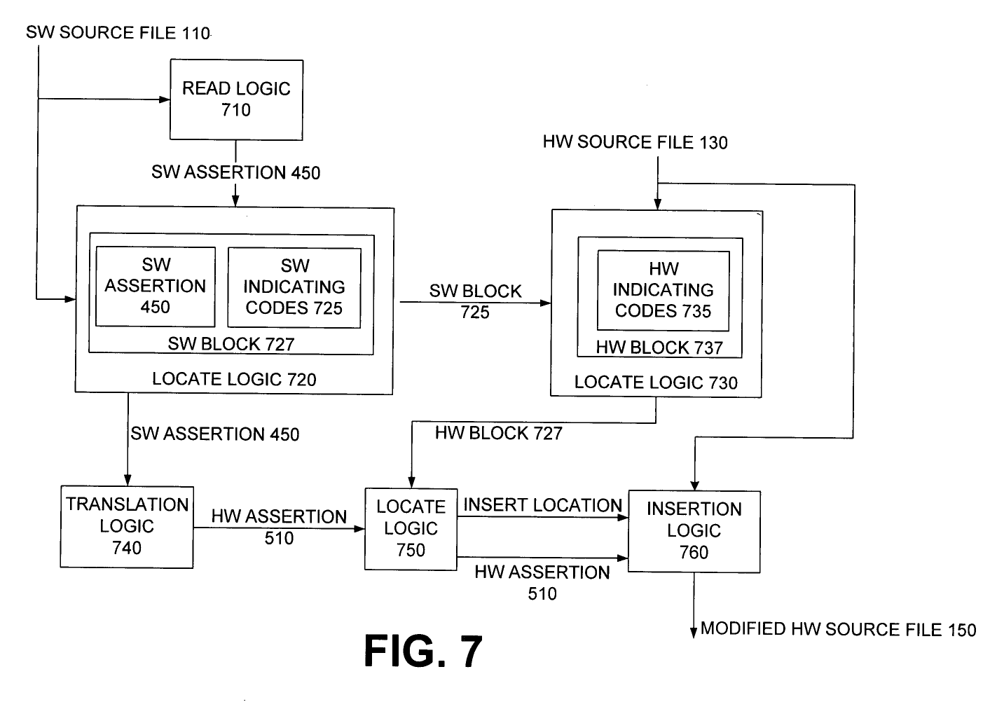

FIG. 7 is a block diagram of one embodiment of a system for transferring software assertions into HDL code as described in connection with FIGS. 1-6. Read logic 710 reads a software assertion (450) from a software source file (110). Read logic 710 also determines which software module (410S) the software assertion is located in, within the source file (110),

First locate logic 720 determines the location of the software assertion (450) relative to one or more blocks (420S, 430S) within the software module (410S). In one embodiment, the location in the software file (110) is captured by first locate logic 720 in terms of the code within the blocks. Since this code indicates a software location, the location can be viewed as comprising software indicating codes (725). First locate logic 720 maintains, or sets, a software block (727) which includes the software assertion (450) and the software indicating codes (725).

Second locate logic 730 searches the hardware source file (150) to find a hardware block (420H) which corresponds to the software block (420S). In one embodiment, the location of the corresponding hardware block (420H) is captured in terms of code within the block, i.e., in terms of hardware indicating codes (735). Thus, the software indicating codes (725) correspond to the hardware indicating codes (735). Second locate logic 730 maintains, or sets, a hardware block (737) which includes the hardware indicating codes (735).

Translate logic 740 translates the software assertion (450) into an hardware assertion (510). Third locate logic 750 uses the hardware indicating codes (735), which describe a location within hardware module (420H), to determine a location within the HDL file (130) for insertion of the translated assertion (510). The determined location is relative to the hardware indicating codes (735).

Insertion logic 760 inserts the translated hardware assertion (510) at the determined location within the HDL source file (130). The end result is a hardware source file (150) containing translated assertions which correspond to the assertions in the software source file (130).

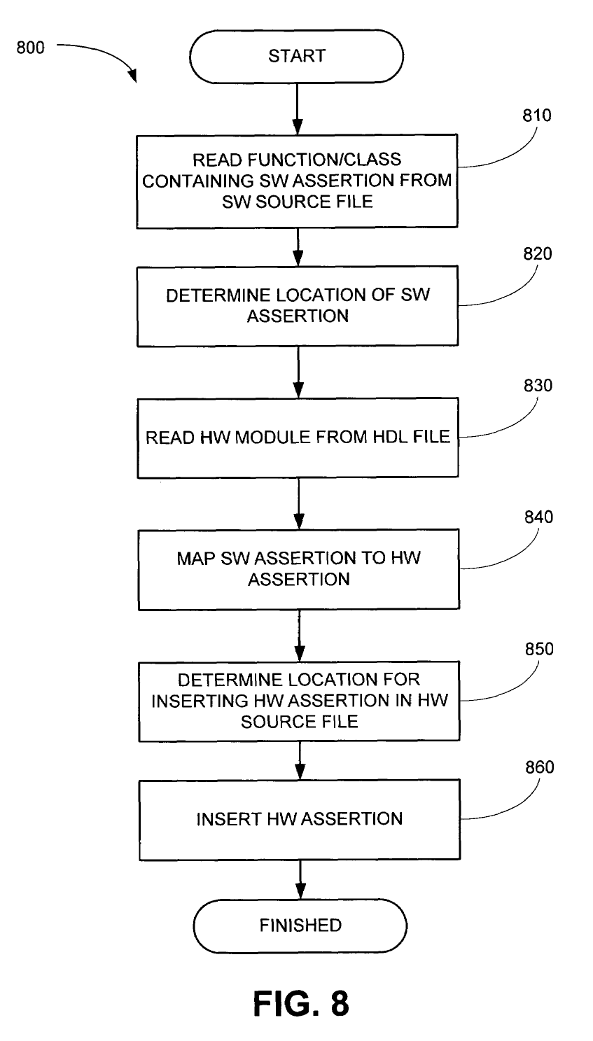

FIG. 8 is a flowchart of one embodiment of the method of transferring software assertions into HDL code. At block 810, a function or class containing a software assertion is read in from a software source file. Next (block 820), the method determines where the software assertion is located, relative to the various blocks which make up the function or class. At block 830, the method reads in a hardware module that corresponds the software function/class. At block 840, the software assertion is mapped to a hardware assertion. Next, at blocks 850 and 860, the method determines an insertion location for the mapped hardware assertion, and inserts the hardware assertion at that location.

This location can be within the module (a technique called “inline assertions”) or external. In the inline case, the insertion location is relative to blocks within the module, and is based on the location of software assertion within the software module/function. However, allowances are made for differences between the software function and its translated form in the hardware module, as would be understood by one of ordinary skill in the art of program translation.

Any process descriptions or blocks in flowcharts should be understood as representing modules, segments, or portions of code which include one or more executable instructions for implementing specific logical functions or steps in the process. As would be understood by those of ordinary skill in the art of the software development, alternate implementations are also included within the scope of the disclosure. In these alternate implementations, functions may be executed out of order from that shown or discussed, including substantially concurrently or in reverse order, depending on the functionality involved.

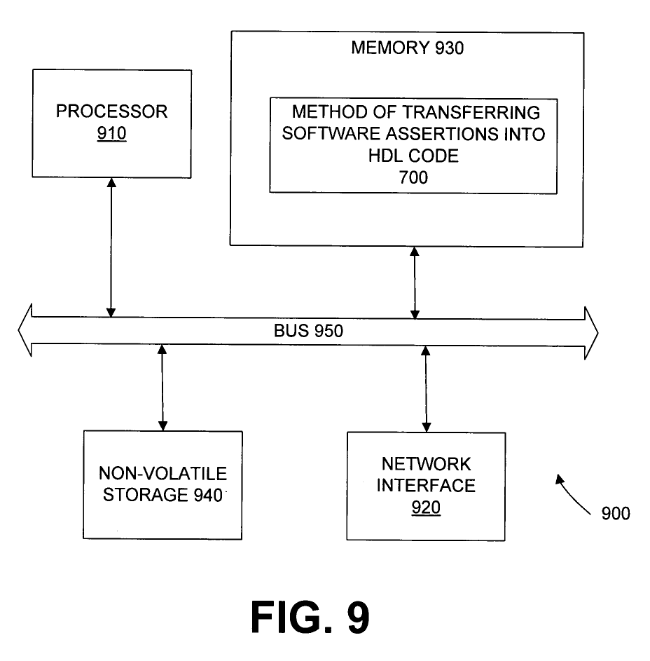

FIG. 9 is a hardware block diagram of a general-purpose computer 900 which can be used to implement the method 700 of transferring software assertions into HDL code. The system 900 contains a number of components that are well known in the art of call center software, including a processor 910, a network interface 920, memory 930, and non-volatile storage 940. Examples of non-volatile storage include, for example, a hard disk, flash RAM, flash ROM, EEPROM, etc. These components are coupled via a bus 950. The memory 930 contains instructions which, when executed by the processor 910, implement the method of transferring software assertions into HDL code. Omitted from FIG. 9 are a number of conventional components, known to those skilled in the art, that are unnecessary to explain the operation of the system 900.

The systems and methods for transferring software assertions into HDL code can be implemented in software, hardware, or a combination thereof. In some embodiments, the system and/or method is implemented in software that is stored in a memory and that is executed by a suitable microprocessor (UP) situated in a computing device. However, the systems and methods can be embodied in any computer-readable medium for use by or in connection with an instruction execution system, apparatus, or device. Such instruction execution systems include any computer-based system, processor-containing system, or other system that can fetch and execute the instructions from the instruction execution system. In the context of this disclosure, a “computer-readable medium” can be any means that can contain, store, communicate, propagate, or transport the program for use by, or in connection with, the instruction execution system. The computer readable medium can be, for example but not limited to, a system or propagation medium that is based on electronic, magnetic, optical, electromagnetic, infrared, or semiconductor technology.

Specific examples of a computer-readable medium using electronic technology would include (but are not limited to) the following: an electrical connection (electronic) having one or more wires; a random access memory (RAM); a read-only memory (ROM); an erasable programmable read-only memory (EPROM or Flash memory). A specific example using magnetic technology includes (but is not limited to) a portable computer diskette. Specific examples using optical technology includes (but are not limited to): an optical fiber; and a portable compact disk read-only memory (CD-ROM).

Note that the computer-readable medium could even be paper or another suitable medium on which the program is printed. Using such a medium, the program can be electronically captured (using, for instance, optical scanning of the paper or other medium), compiled, interpreted or otherwise processed in a suitable manner, and then stored in a computer memory. In addition, the scope of the certain embodiments of the present invention includes embodying the functionality of the preferred embodiments of the present invention in logic embodied in hardware or software-configured mediums.

This description has been presented for purposes of illustration and description. It is not intended to be exhaustive or to limit the disclosure to the precise forms disclosed. Obvious modifications or variations are possible in light of the above teachings. The embodiments discussed, however, were chosen to illustrate the principles of the disclosure, and its practical application. The disclosure is thus intended to enable one of ordinary skill in the art to use the disclosure, in various embodiments and with various modifications, as are suited to the particular use contemplated. All such modifications and variation are within the scope of this disclosure, as determined by the appended claims when interpreted in accordance with the breadth to which they are fairly and legally entitled.

1. A method for transferring assertions in a software programming language source file to a hardware design language (HDL) source file, the method comprising the steps of:
reading a software assertion from a first source file containing source code in a software programming language, the software assertion being located in a first block;
locating a second block, corresponding to the first block, within a second source file containing HDL source code that is translated from the source code in the first source file, the second source file excluding assertions that are translated from the source code in the first source file;
mapping the software assertion to a hardware assertion expressed in the HDL;
determining a location within the second block for insertion of the hardware assertion; and
inserting the hardware assertion at the determined location within the second source file.

2. The method of claim 1, wherein the first source file comprises at least one top-level software entity, and the second source file comprises at least one top-level hardware entity, each entity comprising at least one block, the method further comprising:
determining which top-level software entity contains the software assertion;
determining a location of the software assertion relative to other blocks in the top-level software entity containing the software assertion;
determining which top-level hardware entity corresponds to the top-level software entity containing the software assertion; and
determining, based on the location of the software assertion, an insertion location within the top-level hardware entity, for insertion of the hardware assertion.

3. The method of claim 1, further comprising:
locating a software assertion in a first block within a top-level software entity contained in the first source file; and
determining the name of the second source file, the second source file containing the top-level hardware entity corresponding to the top-level software entity.

4. The method of claim 3, wherein the top-level software entity is a function and the top-level hardware entity is a module.

5. The method of claim 4, wherein the function and the module are each comprised of blocks, the method further comprising:
determining a location of the software assertion, relative to other blocks in the function;
determining a plurality of top-level hardware block locations, each of the block locations being the location of a block in the module;
determining an insertion location in the module, the insertion location being relative to the one of the top-level hardware block locations that corresponds to software assertion location; and
inserting the hardware assertion at the insertion location in the module.

6. The method of claim 1, further comprising:
reading a first set of software programming language source files containing the first source file;
building a first structure representing the hierarchy of the first set of source files; and
determining which of the second set of HDL source files corresponds to the second source file by traversing the first structure.

7. The method of claim 1, wherein the software assertion includes a boolean expression and an output string.

8. The method of claim 1, wherein the hardware assertion includes a property definition.

9. A system for transferring assertions in a first source file to a second source file, the first source file containing source code in a software programming language, the second source file containing HDL source code, the system comprising:
read logic configured to read a software assertion from the first source file;
first locate logic configured to set a first block, which includes the software assertion and at least one software location indicating code within the first source file, to determine the relative location of the software assertion in relation to the software location indicating code in the first block;
second locate logic configured to set a second block, corresponding to the first block, within the second source file by searching the second source file for the at least one hardware location indicating code corresponding to the at least one software location indicating code;
translate logic configured to translate the software assertion into a hardware assertion;
third locate logic configured to determine an insertion location, relative to the at least one hardware location indicating code within the second block; and
insert logic configured to insert the hardware assertion at the determined location within the second source file.

10. The system of claim 9, wherein the first source file comprises at least one top-level software entity, and the second source file comprises at least one top-level hardware entity, each entity comprising at least one block, further comprising:
logic configured to determine which top-level software entity contains the software assertion;
logic configured to determine a location of the software assertion relative to other blocks in the top-level software entity containing the software assertion;
logic configured to determine which top-level hardware entity corresponds to the top-level software entity containing the software assertion; and
logic configured to determine, based on the location of the software assertion, an insertion location within the top-level hardware entity, for insertion of the hardware assertion.

11. The system of claim 9, further comprising:
logic configured to locate a software assertion in a first block within a top-level software entity contained in the first source file; and
logic configured to determine the name of the second source file, the second source file containing the top-level hardware entity corresponding to the top-level software entity.

12. The system of claim 11, wherein the top-level software entity is a function and the top-level hardware entity is a module.

13. The system of claim 11, wherein the top-level software and hardware entities are comprised of blocks, and further comprising:
logic configured to determine a location of the software assertion, relative to other blocks in the top-level software entity;
logic configured to determine a plurality of top-level hardware block locations, each of the block locations being the location of a block in the top-level hardware entity;
logic configured to determine an insertion location corresponding to the location of the software assertion; and
logic configured to insert the hardware assertion at the corresponding top-level hardware location.

14. The system of claim 9, further comprising:
logic configured to read a first set of software programming language source files containing the first source file;
logic configured to build a first structure representing the hierarchy of the first set of source files; and
logic configured to determine which of the second set of HDL source files corresponds to the second source file by traversing the first structure.

15. The system of claim 9, wherein the software assertion includes a boolean expression and an output string.

16. The system of claim 9, wherein the hardware assertion includes a property definition.

17. A method for transferring assertions in a software programming language source file to a hardware design language (HDL) source file, the method comprising the steps of:
reading a software assertion from a first source file, the first source file containing source code in a software programming language;
determining a location of the software assertion within a software function;
reading a hardware module from a second source file, the hardware module corresponding to the software function, the second source file containing HDL source code that is translated from the source code in the first source file and excluding assertions that are translated from the source code in the first source file;
mapping the software assertion to a hardware assertion expressed in the HDL;
determining, based on the location of the software assertion, an insertion location within the hardware module, for insertion of the hardware assertion; and
inserting the hardware assertion at the determined insertion location.

18. The method of claim 17, wherein the software function and the hardware module are comprised of blocks, the method further comprising:
determining the location of the software assertion relative to other blocks in the software function;
determining a plurality of hardware block locations, each of the block locations being the location of a block in the hardware module;
determining which of the hardware block locations corresponds to the location of the software assertion; and
inserting the hardware assertion at the corresponding hardware block location.

19. The method of claim 17, wherein the software assertion includes a boolean expression and an output string.

20. The method of claim 17, wherein the hardware assertion includes a property definition.
